(19) United States
(12) Patent Application Publication
(10) Pub. No.: US 2008/0266256 A1
(43) Pub. Date: Oct. 30, 2008

(54) Keyboard, mouse and video switch system

(76) Inventor: Yu-Tuan Lee, Taipei (TW)

Correspondence Address: BIRCH STEWART KOLASCH & BIRCH, PO BOX 747, FALLS CHURCH, VA, 22040-0747, US

(21) Appl. No.: 11/797,061

(22) Filed: Apr. 30, 2007

(51) Int. Cl. G06F 3/033

(52) U.S. Cl. 345/163

(57) ABSTRACT

A wireless keyboard and mouse switch system includes a wireless keyboard/mouse set and a server side wireless receiver. The wireless keyboard/mouse set transmits a server selection signal and a user input data wirelessly. The server side wireless receiver is connected to a host server computer and receives the server selection signal. The server selection signal selects the server side wireless receiver to receive the user input data and to send the user input data to the host server computer.

### BACKGROUND OF THE INVENTION

1. Field of Invention

The invention relates to a switch system, and, in particular, to a keyboard, mouse and video switch system.

2. Related Art

Referring to FIG. 1, a conventional keyboard, video and mouse switch system (KVM switch) includes a switch 13, a keyboard 14, a mouse 15 and a monitor 16. The keyboard 14, mouse 15 and monitor 16 are connected to switch 13, and thus they are selectively connected to the server 11a or 11b through the cable 12a and 12b. So the user can operate one input set (the keyboard 14 and mouse 15) to control multiple servers 12a and 12b. Since the connections are all wired, the system requires a lot of cables which is bulky and not good for management. In addition, the input devices (keyboard 14 and mouse 15) are only connected to one server at a time, and thus the distances between the server and the input devices are also limited by the length of the cable. Therefore, the total number of connectible servers is limited by the physical port numbers of the switch 13.

### SUMMARY OF THE INVENTION

In view of the foregoing, the invention is to provide a wireless keyboard, mouse and video switch system.

To achieve the above, a wireless keyboard and mouse switch system includes a wireless keyboard/mouse set and a server side wireless receiver. The wireless keyboard/mouse set transmits a server selection signal and a user input data wirelessly. The server side wireless receiver is connected to a host server computer and receives the server selection signal. The server selection signal selects the server side wireless receiver to receive the user input data and to send the user input data to the host server computer.

To achieve the above, a wireless keyboard and mouse switch system includes a wireless keyboard/mouse set, a server side wireless receiver, a server side video transmitter and a video receiver. The wireless keyboard/mouse set transmits a server selection signal and a user input data wirelessly. The server side wireless receiver is connected to a host server computer and receives the server selection signal. The server selection signal selects the server side wireless receiver to receive the user input data and to send the user input data to the host server computer. The server side video transmitter is connected to a video output port of the host server computer. The server side wireless receiver selected by the server selection signal controls the server side video transmitter to transmit a video signal outputted from the video output port of the host server computer. The video receiver receives the video signal and sending the video signal to a monitor to display.

As mentioned above, according to wireless human interface device switch system, the system avoids the connection limitation of the conventional KVM switch systems, and provides the capability of connecting to multiple servers at the same time. The system also provides a longer distance by eliminating the limitation of the cable's length, and the total number of the connectible servers is no longer limited to the physical port numbers.

### BRIEF DESCRIPTION OF THE DRAWINGS

The invention will become more fully understood from the detailed description given herein below illustration only, and thus is not limitative of the present invention, and wherein:

FIGS. 1 is a block diagram showing a conventional KVM system; and

FIGS. 2 is a block diagram showing the wireless KVM system according to the preferred embodiment of the invention.

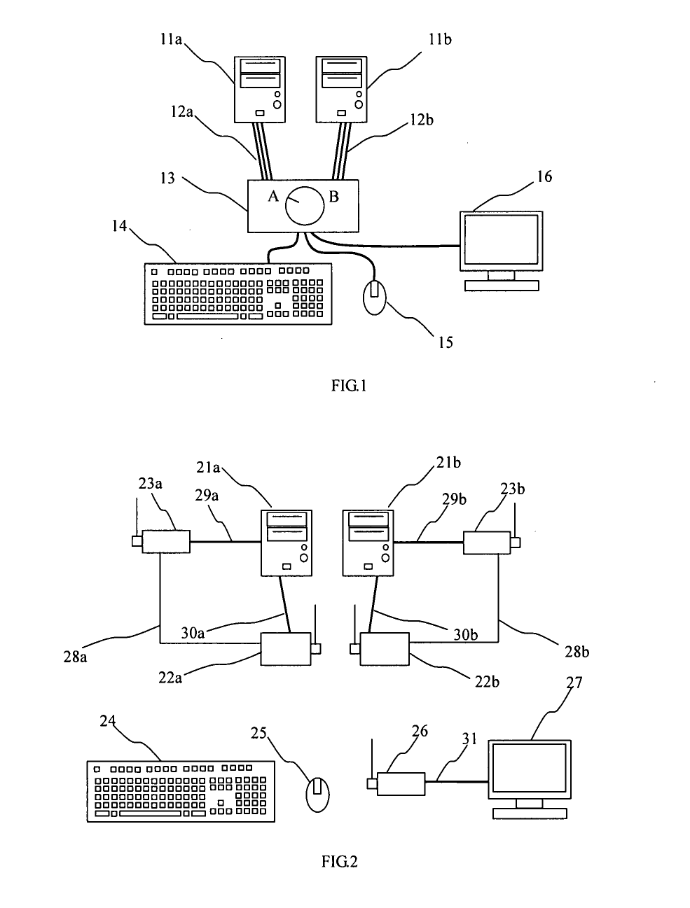

### DETAILED DESCRIPTION OF THE INVENTION

The present invention will be apparent from the following detailed description, which proceeds with reference to the accompanying drawings, wherein the same references relate to the same elements.

Referring to FIG. 2, a wireless keyboard, mouse and video switch system includes two host server computer 21a and 21b, two server side wireless receiver 22a, and 22b, two server side video transmitters 23a and 23b, and a wireless keyboard/mouse set having a wireless keyboard 24 and a wireless mouse 25, a video receiver 26, a monitor 27, a control line 28a and 28b, a video cable 29a and 29b, and cables 30a, 30b and 31.

The wireless keyboard/mouse set (wireless keyboard 24 and/or wireless mouse 25) transmits a server selection signal and a user input data wirelessly. The server side wireless receiver 22a and 22b are connected to host server computers 21a and 21b respectively, and they receive the server selection signal. The server selection signal selects the server side wireless receivers 22a and/or 22b to receive the user input data and to send the user input data to the corresponding host server computer 21a and/or 21b. The server side video transmitter 23a and 23b are connected to a video output port of the host server computers 21a and 21b respectively. When the server side wireless receiver 22a is selected by the server selection signal, it controls the corresponding server side video transmitter 23a to transmit a video signal outputted from the video output port of the host server computer 21a. When the server side wireless receiver 22b is selected by the server selection signal, it controls the corresponding server side video transmitter 23b to transmit a video signal outputted from the video output port of the host server computer 21b. The video receiver 26 receives the video signal and sending the video signal to the monitor 27 to display.

The server side wireless receiver 22a and 22b have a receiving antenna for receiving the server selection signal respectively. The server side wireless receiver 22a does not transmit the user input data when the server selection signal does not select the server side wireless receiver 22a. The server side wireless receiver 22b does not transmit the user input data when the server selection signal does not select the server side wireless receiver 22b. The server selection signal selects the desired server side wireless receiver 22a and/or 22b to start communication with the corresponding host server computer 21a and/or 21b.

The server side wireless receiver 22a or 22b selected by the server selection signal generates a video control signal to the server side video transmitter 23a or 23b, and the server side video transmitter 23a or 23b sends the video signal to the monitor according to the video control signal. The server side video transmitter 23a or 23b sends the video signal when the video control signal is an activating signal, and the server side video transmitter 23a or 23b does not send the video signal when the video control signal is a deactivating signal. The server side video transmitter 23a or 23b sends the video signal to the video receiver 26 wirelessly.

In the embodiment, the server side wireless receiver 22a is connected to the input port of the server 21a through cable 30a, and the server side wireless receiver 22a outputs a video control signal to the server side video transmitter 23a through control line 28a. The server side video transmitter 23a is connected to the video output port of the server 21a through the cable 29a. The server side wireless receiver 22b is connected to the input port of the server 21b through cable 30b, and the server side wireless receiver 22b output a video control signal to the server side video transmitter 23b through control line 28b. The server side video transmitter 23b is connected to video output port of the server 21b through cable 29b. The output of the video receiver 26 is connected to monitor 27 through cable 31.

The wireless keyboard 24 has the server selection keys for selecting the server side wireless receiver 22a or the server side wireless receiver 22b. When the user wants to transmit his input data to host server computer 21a, he presses the server selection key for the server side wireless receiver 22a on the wireless keyboard 24 to generate the server selection signal. Then the wireless keyboard 24 will transmit the server selection signal of the server side wireless receiver 22a.

The server side wireless receiver 22a and 22b receive the selection signal, and the server selection signal selects the server side wireless receiver 22a to start to process the user input data from the wireless keyboard 24, and output a video control signal (an activation signal) on the control line 28a to activate the server side video transmitter 23a. Then the activated server side video transmitter 23a will start to send the video signal of the host server computer 21. At the same time, the unselected server side wireless receiver 22b will stop sending the received user input data, and it outputs a video control signal (a deactivation signal) on the control line 28b. The video control signal controls the server side video transmitter 23b stop sending video data. With the similar operation, when the user wants to input his data to the server 21b, he just presses the selection key for server side wireless receiver 22b on the wireless keyboard 24, and thus the system will switch to server 21b.

As described above, the system has no cable length limitation, it is very easy to install. Besides, there is no limitation in expansion. If a new server is needed to join the system, the user just adds a server side wireless receiver and a server side video transmitter. Therefore, there is no physical port limitation in the number of connectible servers.

As mentioned above, according to wireless human interface device switch system, the system avoids the connection limitation of the conventional KVM switch systems, and provides the capability of connecting to multiple servers at the same time. The system also provides a longer distance by eliminating the limitation of the cable's length, and the total number of the connectible servers is no longer limited to the physical port numbers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless keyboard and mouse switch system, comprising:
a wireless keyboard/mouse set transmitting a server selection signal and a user input data wirelessly; and
a server side wireless receiver connected to a host server computer and receiving the server selection signal, wherein the server selection signal selects the server side wireless receiver to receive the user input data and to send the user input data to the host server computer.

2. The wireless keyboard and mouse switch system as recited in claim 1, wherein the wireless keyboard/mouse set comprises a wireless keyboard or a wireless mouse.

3. The wireless keyboard and mouse switch system as recited in claim 1, wherein the server side wireless receiver does not transmit the user input data when the server selection signal does not select the server side wireless receiver.

4. The wireless keyboard and mouse switch system as recited in claim 1, wherein the server side wireless receiver comprises:
a receiving antenna receiving the server selection signal.

5. The wireless keyboard and mouse switch system as recited in claim 1, wherein the wireless keyboard/mouse set comprises:
a server selection key pressed to generate the server selection signal.

6. The wireless keyboard and mouse switch system as recited in claim 1, wherein the server selection signal selects the desired server side wireless receiver to start communication with the host server computer.

7. A wireless keyboard, mouse and video switch system, comprising:
a wireless keyboard/mouse set transmitting a server selection signal and a user input data wirelessly;
a server side wireless receiver connected to a host server computer and receiving the server selection signal, wherein the server selection signal selects the server side wireless receiver to receive the user input data and to send the user input data to the host server computer;
a server side video transmitter connected to an video output port of the host server computer, wherein the server side wireless receiver selected by the server selection signal controls the server side video transmitter to transmit a video signal outputted from the video output port of the host server computer; and
a video receiver receiving the video signal and sending the video signal to a monitor to display.

8. The wireless keyboard, mouse and video switch system as recited in claim 7, wherein the wireless keyboard/mouse set comprises a wireless keyboard or a wireless mouse.

9. The wireless keyboard, mouse and video switch system as recited in claim 7, wherein the server side wireless receiver does not transmit the user input data when the server selection signal does not select the server side wireless receiver.

10. The wireless keyboard, mouse and video switch system as recited in claim 7, wherein the server side wireless receiver comprises:
a receiving antenna receiving the server selection signal.

11. The wireless keyboard, mouse and video switch system as recited in claim 7, wherein the wireless keyboard/mouse set comprises:
a server selection key pressed to generate the server selection signal.

12. The wireless keyboard, mouse and video switch system as recited in claim 7, wherein the server selection signal selects the desired server side wireless receiver to start communication with the host server computer.

13. The wireless keyboard, mouse and video switch system as recited in claim 7, wherein the server side wireless receiver selected by the server selection signal generates a video control signal to the server side video transmitter, and the server side video transmitter sends the video signal to the monitor according to the video control signal.

14. The wireless keyboard, mouse and video switch system as recited in claim 13, wherein the server side video transmitter sends the video signal when the video control signal is an activating signal, and the server side video transmitter does not send the video signal when the video control signal is a deactivating signal.

15. The wireless keyboard, mouse and video switch system as recited in claim 7, wherein the server side video transmitter sends the video signal to the video receiver wirelessly.
